(19) United States
(12) Patent Application Publication
(10) Pub. No.: US 2008/0272050 A1
(43) Pub. Date: Nov. 6, 2008

(54) Multi-Barrier Water Purification System and Method

(75) Inventors: Brian E. Butters, London (CA); Anthony L. Powell, London (CA)

Correspondence Address: BAKER & MCKENZIE LLP;PATENT DEPARTMENT, 2001 ROSS AVENUE, SUITE 2300, DALLAS, TX, 75201, US

(73) Assignee: Purifics Environmental Technologies, Inc., London (CA)

(21) Appl. No.: 12/115,429

(22) Filed: May 5, 2008

Related U.S. Application Data
(60) Provisional application No. 60/916,190, filed on May 4, 2007.

(51) Int. Cl. C02F 3/02

(52) U.S. Cl. 210/620; 210/167.3

(57) ABSTRACT

Disclosed herein are systems and methods for decontaminating a contaminated fluid that integrate ultraviolet radiation in an advanced decontamination process, and a honing material, along with a cross-flow membrane filter, into a single closed-loop system. This approach combines the advantages of chemical-free advanced decontamination technology, long-life wiper-free UV disinfections, and maintenance-free ceramic MF/UF membranes to provide multi-barrier protection. Such technique provides a 100% fluid recovery system (zero reject stream). In one embodiment, the system comprises a filtration membrane and a honing material located in the contaminated fluid that is sufficient to scrub foulants from the membrane, as well as any other components that honing material comes in contact with, while forming a dynamic filtration coating on the membrane as the contaminated fluid pass through the membrane. The system may also comprise an advanced decontamination process sufficient to destroy, by oxidation or reduction, biological and organic contaminants from the contaminated fluid.

### CROSS-REFERENCE TO RELATED APPLICATIONS

This application claims the benefit of U.S. Provisional Patent Application Ser. No. 60/916,190, filed on May 4, 2007, and entitled “WATER PURIFICATION SYSTEM AND METHOD,” which is commonly assigned with the present application and incorporated herein by reference for all purposes.

### TECHNICAL FIELD

The present disclosure relates generally to purification systems and methods, and more particularly to chemical-free systems and methods for purifying contaminated fluids using a multiple barrier approach.

### BACKGROUND

Since almost all forms of life need water to survive, the improvement of water quality in decontamination systems has typically been a subject of significant interest. As a result, treatment systems and techniques for removing contaminants from contaminated fluids have been developed in the past. Prior approaches have included water treatment by applying various microorganisms, enzymes and nutrients for the microorganisms in water. Other approaches involve placing chemicals in the contaminated fluids, such as chlorine, in an effort to decontaminate supplies. Some such systems have proved to be somewhat successful; however, severe deficiencies in each approach may still be prominent.

In some prior systems, solid reactants are used that have to be dissolved or dispersed prior to use, or were cumbersome and not particularly suited for prolonged water treatment, or could not be used in a wide variety of different types of applications. In particular, the handling of the solid reactants often posed problems with respect to different dissolution rates, concentrations and growth rates. In addition, in systems employing chemical additives, the resulting “decontaminated” fluid may actually now be contaminated by these chemicals, in spite of having removed the original biological or other contaminants from the media. Even in systems employing microfiltration, problems with the system may not be from any sort of additive, but instead may simply be the clogging of the filter elements or membranes with foulants accumulated from the decontamination process. Time-consuming filter cleaning processes combined with system downtime can become costly and inefficient for purification companies.

Some more advanced treatment systems and techniques include treatments using a photolytic or a photocatalytic process. Common photocatalytic treatment methods typically make use of a technique by which a photocatalyst is bonded to contaminants in order to destroy such biomaterials. Specifically, photocatalytic reactions are caused by irradiating electromagnetic radiation, such as ultraviolet light, on the fixed photocatalyst so as to activate it. Resulting photocatalytic reactions bring about destruction of contaminants, such as volatile organic contaminants or other biologically harmful compounds that are in close proximity to the activated photocatalyst. However, employing such photocatalytic systems alone may be ineffective for use in 100% recycle closed-loop systems, or may impose equipment size or cost restrictions for some applications.

Accordingly, the search has continued for chemical-free decontamination systems and processes that may be employed for closed-loop, 100% product recovery systems, but that do not suffer from the deficiencies found in conventional approaches.

### SUMMARY

Systems and methods constructed and operated in accordance with the principles disclosed herein integrate, in some embodiments, ultraviolet (UV) radiation in an advanced oxidation process (AOP), and a honing material, along with a cross-flow membrane filter technology into a single closed-loop system. In exemplary embodiments, the disclosed approach combines the advantages of chemical-free AOP technology, long-life wiper-free UV disinfections, and maintenance-free ceramic MF/UF membranes to provide durable multi-barrier decontamination and protection for potable drinking water or any type of contaminated water. Such systems and methods provide a 100% fluid recovery system (i.e., zero reject stream) without the use of aggressive oxidants (such as hydrogen peroxide and ozone) added to the system. Such a combination has not been provided in conventional approaches, and thus the disclosed systems and processes provide enhanced performance over the sum of the individual technologies.

In one aspect, a closed-loop system for decontaminating a contaminated fluid is provided. In one embodiment, the system comprises a filtration membrane. In addition, the system could comprise a honing material located in the contaminated fluid that is sufficient to scrub foulants from the filtration membrane, as well as other system components, as the contaminated fluid is filtered by the filtration membrane. Also, in such embodiments, the system comprises an Advanced Decontamination Process sufficient to destroy or otherwise eliminate, by oxidation or reduction, biological and organic contaminants from the contaminated fluid.

In another aspect, a method of decontaminating a contaminated fluid within a closed-loop system is provided. In one embodiment, the method comprises passing the contaminated fluid through a filtration membrane. In addition, such a method could comprise providing a honing material in the contaminated fluid, where the honing material is sufficient to scrub foulants from the filtration membrane, as well as other system components, as the contaminated fluid is passing through the filtration membrane. Furthermore, such a method could comprise performing an Advanced Decontamination Process on the contaminated fluid sufficient to destroy, by oxidation or reduction, biological and organic contaminants from the contaminated fluid.

In yet another aspect, a more specific closed-loop system for decontaminating a contaminated fluid is provided. In one embodiment, such a system comprises a cross-flow filtration membrane, and a photocatalytic slurry placed in the contaminated fluid. The photocatalytic slurry has a texture that is sufficient to scrub foulants from the filtration membrane as the contaminated fluid is filtered by the filtration membrane, as well as from other system components. In addition, in such embodiments, the system further includes a UV light source providing a photolytic reaction sufficient to disinfect contaminants in the contaminated fluid. Still further, in such an embodiment the system could also include an Advanced Decontamination Process comprising a photocatalytic reaction, caused by the UV light source, between the photocatalytic slurry and contaminants in the contaminated fluid sufficient to oxidize and thereby destroy biological and organic contaminants in the contaminated fluid.

### BRIEF DESCRIPTION OF THE DRAWINGS

Embodiments are illustrated herein by way of example in the accompanying figures, in which like reference numbers indicate similar parts, and in which:

FIG. 1 illustrates one embodiment of a conventional cross-flow filtration system for filtering contaminated liquid media;

FIG. 2 illustrates one embodiment of a closed-loop cross-flow filtration system for filtering contaminated liquid media; and

FIG. 3 illustrates one embodiment of a closed-loop multi barrier cross-flow filtration system for filtering contaminated liquid media and constructed in accordance with the disclosed principles.

### DETAILED DESCRIPTION

Referring initially to FIG. 1, illustrated is one embodiment of a conventional cross-flow filtration system 100 for filtering contaminated liquid media. The system 100 includes a source of contaminated media 110, which in this type of system is typically a fluid such as contaminated water 110. The contaminated fluid 110 may be retrieved from a storage tank or reservoir, or from any other available source.

The contaminated fluid 110 is transferred, via a pump 120, to a filtration member 130. Specifically, the contaminated fluid 110 is pumped through a cross-flow filter 130 for filtering out contaminants in the fluid. In some embodiments, the cross-flow filter 130 is a membrane filter, such as a ceramic membrane. The advantages of a ceramic membrane are the durability of such membranes, as well as their ability to filter out very small contaminants. In such conventional systems 100, the cross-flow filter 130 filters the contaminates so that the filtered fluid, or permeate 140, may be collected. The filtered contaminants are expelled from the system 100 as reject 150. The reject 150 must then be collected and properly disposed of

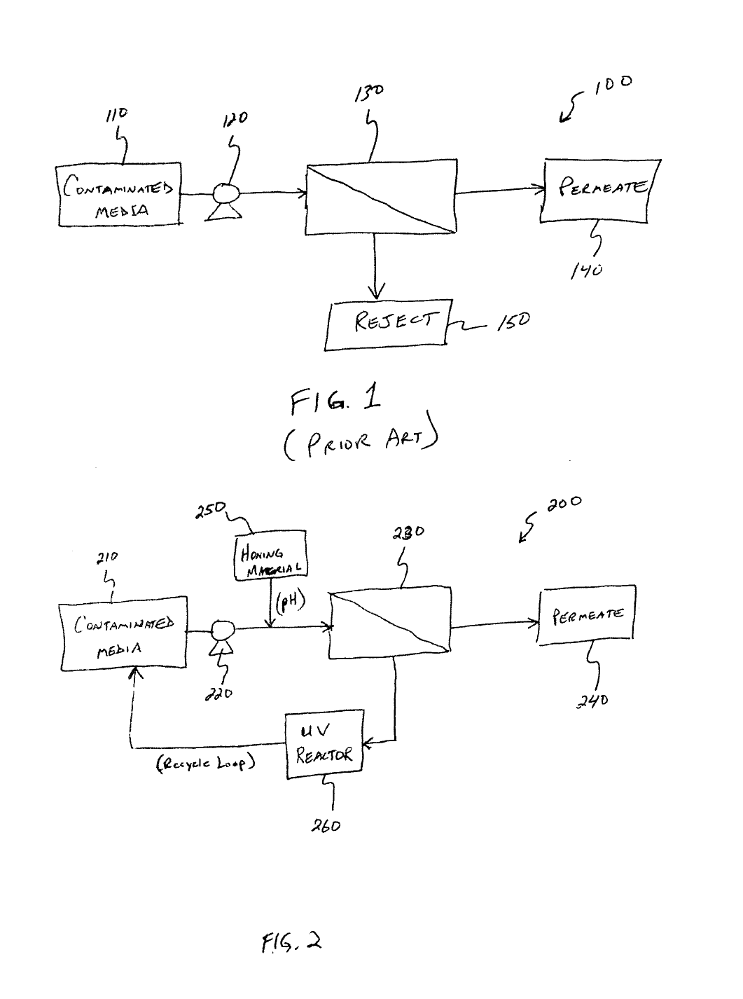

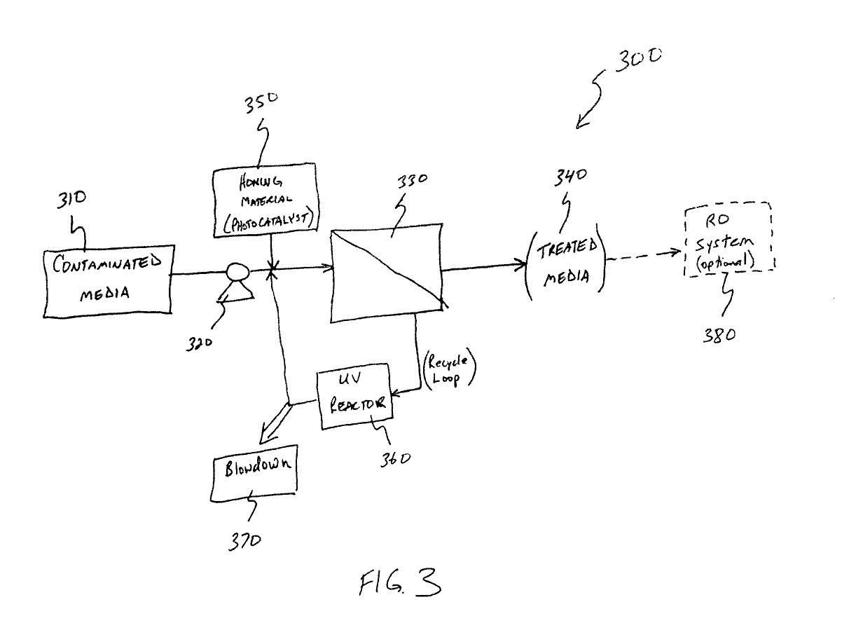

Turning now to the FIG. 2, illustrated is one embodiment of a closed-loop cross-flow filtration system 200 for filtering contaminated liquid media. The system 200 includes a source of contaminated media 210, again typically a fluid such as contaminated water 210. The contaminated fluid 210 may be retrieved from a storage tank or reservoir, or from any other available source. The contaminated fluid 210 is transferred, via a pump 220, to a cross-flow filtration member 230. In some embodiments, the cross-flow filter 230 is again a ceramic membrane.

In these types of systems 200, filtration of the contaminated media 210 may be performed using cross-flow filtration with basically no fouling of the membrane 230 in the system 200, but also with no reject from the system 200. As the closed-loop system 200 filters the contaminated fluid 210, permeate 240 is collected from the system 200. Fluid that still contains some contaminants is recycled back to the contaminated media 210 source via a recycle loop.

However, some embodiments require the contaminant itself to help maintain the cross-flow filter membrane 230 clean. For example, such a system 200 functions relatively well where the contaminated media 210 is populated with aggregate fines. Such applications may include the collection of water from a quarry, where the water is used to assist in the cutting of certain stone (e.g., limestone). Fine particles of the stone (i.e., the aggregate fines) collect in the water, and that now-contaminated water may need to be filtered. In such a system, two protection barriers are present: (1) the aggregate fines are a honing material, and (2) pH in limestone and similar aggregate fines is very basic (very high). Thus, in such closed-loop systems 200 where the contaminant is not a biological or organic contaminant, two barriers help to keep the cross-flow membrane 230 clean:
(1) keeping a honing material in the loop helps knock off foulants on the membrane when passing through it; and
(2) maintaining a pH level in the loop to further prevent fouling of the membrane.

In other embodiments, the contaminant itself does not provide the honing capabilities. As a result, a honing material 250 may be added to the system 200 to provide this benefit. Moreover, the added honing material 250 may also provide the higher pH level desired, again if the contaminant itself does not provide it.

The addition of a UV reactor 260 may help maintain the cleanliness of the cross-flow filter membrane 230 even further. The addition of UV light to the contaminated fluid 210 can help disinfect the fluid within the closed-loop. However, even in such a system, the aggregate fines or other contaminants are not a photocatalyst. Therefore, an advanced decontamination process (e.g., decontamination by oxidation) is not provided in the closed-loop of the system 200. As a result, even the benefits of the UV reactor 260 are limited in such embodiments. Thus, for the system illustrated in FIG. 2, in order to provide a no fouling/no reject process, various fouling issues may arise depending on what is being filtered. For example, adding a honing material may be enough, or perhaps the species being filtered (e.g., limestone aggregate fines) may itself be the honing material. However, if the contaminant is biologic or an organic VOC, then a UV reactor added to the loop to disinfect the fluid may not be sufficient. According, a decontamination system employing oxidation and/or reduction as discussed below may be beneficial.

FIG. 3 illustrates one embodiment of a closed-loop multi-barrier cross-flow filtration system 300 for filtering contaminated liquid media, which is constructed in accordance with the disclosed principles. The disclosed system 300, and a related method of purifying contaminated fluid, may be used to decontaminate and thereby purify media 310 containing organic contaminants, biological species, suspended solids, and metals, in a single unit operation. This is done through the integration of a multi-barrier decontamination process.

Generally, systems and methods constructed and operated in accordance with the principles disclosed herein integrate, in some embodiments, ultraviolet (UV) radiation in an advanced decontamination process and a honing material, along with a cross-flow membrane filter technology, into a single closed-loop system. In exemplary embodiments, the disclosed approach combines the advantages of chemical-free advanced decontamination technology, long-life wiper-free UV disinfections, and maintenance-free ceramic MF/UF membranes to provide durable multi-barrier protection for potable drinking water and other contaminated water/fluid sources. Such systems and methods provide a 100% fluid recovery system (i.e., zero reject stream), even without the use of aggressive oxidants (such as hydrogen peroxide and ozone) added to the system. Also, the operation of the system 300 without peroxide, ozone or other aggressive oxidants is possible, as only dissolved oxygen is needed. Of course, if the advanced decontamination process removes contaminants by reduction, then none of the above are needed. Such a combination has not been provided in conventional approaches, and thus the disclosed systems and processes provide enhanced performance over the sum of the individual technologies. In advantageous implementations, the disclosed principles may be used in the potable water market and reclaimed/reuse water market, but the disclosed technique is not limited to these markets.

In the specific embodiment illustrated in FIG. 3, such an approach includes a closed-loop system 300 using a cross-flow membrane 330 with a honing material 350 and an advanced decontamination process to provide the multi-barrier treatment system. In an exemplary embodiment, the advanced decontamination process is a photocatalytic system, for example, a system incorporating a TiO₂ photocatalytic slurry 350 and a UV reactor 360. In such embodiments, the texture of the TiO₂ slurry provides the honing properties to assist in keeping the filter membrane 330, which may again be ceramic, clean by passing through the membrane during use of the system 300. In addition, this honing property is extended to other system components, such as the metal walls in portions of the equipment and the quartz sleeves that are typically found in the UV lamp portion of the unit. Thus, the disclosed principles provide a reactor design that promotes honing of the filtration membrane, as well as other system components. This honing may be provided by a honing material and/or by turbulent flow within the reactor. This incorporation of the properties of a honing material forms a dynamic filtration coating on the membrane filter that provides tighter filtration pore size at the membrane at the same flux (e.g., L/min per m² of filtration surface area). For example, exemplary systems constructed according to the disclosed principles can provide filtration at the rate of 2000 gal/ft² per day with an effective 12 nm filtration pore size at the membrane, versus conventional effective UF of a range of only about 50 gal/ft2 per day with no honing material in the fluid and using a filter membrane having the same pore size.

Adding UV light from a UV reactor 360 to the photocatalytic slurry provides the advanced decontamination process, which will oxidize and thereby destroy organic, and sterilize/disinfect biological and/or organic contaminants, allowing concentrate to be continuously circulated (i.e., zero reject). Additionally, the UV reactor 360 for a photocatalytic advanced decontamination process may be located in any place in the closed-loop system 300. The UV and advanced decontamination process will destroy, by oxidation (adding electrons) or reduction (removing electrons) depending on the catalyst used in the system, biological activity and keep biomass from fouling the membrane and other system components. Thus, in such systems 300, the membrane 330 acts as an ultimate barrier for most biological species. If a slug of biological species should occur and the biomaterial is not destroyed in the advanced decontamination process subsystem, the membrane 330 will prevent the biomaterial from being discharged and will send the biomaterial back to the advanced decontamination process subsystem for another pass of treatment. This will continue until the biomaterial is destroyed and consumed or otherwise eliminated.

In sum, the honing advantage is provided by the addition of the photocatalyst in this example; thus, it works with systems where aggregate fines are not present to provide the honing portion of the filter membrane 330 (and other system components) cleaning. As a result, the three barriers provided by the exemplary system 300 illustrated in FIG. 3 are:
(1) the filtration provided by a cross-flow filter membrane 330;
(2) the honing properties provided by the photocatalytic slurry 350; and
(3) the UV radiation, when provided to the photocatalytic slurry, provides the oxidation barrier via a photocatalytic reaction between the slurry and the VOCs.
   Thus, the system of FIG. 2 provides only filtration, while the system in FIG. 3 not only provides filtration, but also provides an advanced decontamination process, which can destroy or otherwise eliminate organic VOCs. Still further, systems 300 constructed or operated in accordance with the disclosed principles may include various types of advanced decontamination processes that do not incorporate UV light. For example, H₂O₂ and ozone systems can provide the advantageous advanced decontamination process of the disclosed principles. Moreover, another advantage is that the disclosed system is embodied in a stand-alone unit. Regardless of the type of advanced decontamination process incorporated, the following are typical technologies that may be eliminated by implementing a system or process having multi-barrier protection according to the disclosed principles:
Flocculation—Coagulation—Clarification
Chemical Precipitation
Membrane Separation (MF & UF)
Sand filtration
GAC—carbon adsorption
UV Disinfection
Greensand filters
Ion Exchange
Chemical oxidants

Additionally, the system 300 in FIG. 3 may further incorporate a “blowdown” 370. More specifically, a blowdown 370 may be used to help eliminate suspended solids within the loop that may otherwise remain indefinitely. Thus, accumulated suspended solids can be continuously blown down in a small slip stream (e.g., to breakdown build-up or other accumulation). In such embodiments, small amounts of blown down accumulated suspended solids may be removed from the loop periodically. For example, iron may be detected in the contaminated fluid being purified. With the system in FIG. 3, the iron particles would be oxidized onto the TiO₂. Periodic blow down of the catalyst in order to get rid of some of the iron particles to prevent the build-up of iron in the system, and then add some “clean” photocatalyst back into the system to replace what has been removed with the iron. Such implementations may be considered “bleed and feed” implementations, where clean photocatalyst is added back in the loop as quickly as it is being removed.

In some embodiments, such a blowdown 370 may occur in the recycle loop of the system 300, however, such a placement is not required. Still further, the photocatalyst removed from the loop may also be regenerated. In such embodiments, little or no replacement photocatalyst needs to be purchased since the withdrawn photocatalyst is reused. Alternatively, the entire loop can be completely blown down and replaced as well, rather than a bleed and feed approach.

In addition, a fourth barrier, such as a Reverse Osmosis (or electro-dialysis or other similar) system 380 may also be added to the output of the multi-barrier system. For example, if dissolved solids in the contaminated fluid 310 are desired to be removed. Such dissolved solids may include salt, sodium, etc. Purified contaminated fluid 310 provided by the purification system 300 illustrated in FIG. 3 provides a very clean, filtered fluid output. R.O. filters 380 typically fail during use because the cleanliness of the fluid input to them is somewhat in question. In such cases, the R.O. filter 380 can foul with biological, organic, etc. contaminants and eventually fails. Moreover, the elimination of toxic chemicals from the filtration process provided by the system of FIG. 3 can further prolong the life of the R.O. filter 380. For example, conventional purification techniques require adding chlorine to the contaminated fluid in order to provide some of the benefits of the disclosed purification system. However, the presence of chlorine is highly detrimental to the life of an R.O. filter 380. Typically, another chemical is needed to eliminate the added chlorine. Consequently, chemicals added to remove other chemicals can be costly, and the released fluid may still be tainted, not with biological contaminants, but perhaps with added chemicals. Elimination of cleaning chemicals provides a ‘chemical free’ mode of purification and provides 100% duty—thus eliminating over-sizing of equipment to allow for cleaning downtime.

For example, in ground water systems, such as those found in parts of California, the water supply is obtained so quickly that a large concentration of sodium (e.g., 700 ppm) is often present in the drinking water. Since a typical photocatalytic system 300 as disclosed in FIG. 3 does not necessarily eliminate contaminants such as salt (i.e., sodium) and other dissolved solids, an R.O. system 380 implemented along with a system constructed according to the disclosed principles is especially beneficial. Specifically, the highly filtered output from the system 300 of FIG. 3 provides an exceptionally good input for an R.O. filter 380. Accordingly, not only are all the biological, organic and other similar contaminants removed from the contaminated fluid using the multi-barrier approach disclosed herein, but that previously contaminated fluid may also be passed through an R.O. filter 380 with a highly reduced chance of fouling the R.O. filter 380, and thus allowing the R.O. filter 380 to operate, uninterrupted, for a longer period of time than may typically be available.

In conclusion, in systems implemented to decontaminate only organic or biological contaminants, then no removal of suspended solids needs to be performed. In such implementations, a 100% recycling of the fluid media is provided by the decontamination process. The system in FIG. 3 not only disinfects the contaminated fluid, but also sterilizes it. The net effect of the disclosed approach is a single system that will not only disinfect, but also sterilize biological material. Examples of biological contaminants removed by the disclosed multi-barrier system 300 include algae, protozoa, mold spore, bacteria, viruses, which cannot pass through the ceramic cross-flow filter membrane 330. In addition, even pyrogens may be destroyed by the disclosed system 300. While these are so small that may pass through the filter 330, but the recycling of the closed-loop system will eventually destroy them. In sum, a multi-barrier system or process will destroy and mineralize organic compounds, remove suspended solids, reduce turbidity, reduce color, reduce odor, and remove some heavy metals from contaminated fluid. Moreover, fluid released from such a multi-barrier system 300 may then be fed into an R.O. filter 380 or other similar filter.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A closed-loop system for decontaminating a contaminated fluid, the system comprising:
a filtration membrane;
a honing material in the contaminated fluid sufficient to scrub foulants from the filtration membrane as the contaminated fluid is filtered by the filtration membrane; and
an advanced decontamination process sufficient to destroy, by oxidation and/or reduction, biological and organic contaminants in the contaminated fluid.

2. A closed-loop system according to claim 1, wherein the filtration membrane is a cross-flow filtration membrane.

3. A closed-loop system according to claim 2, wherein the cross-flow filtration membrane is comprised of ceramic.

4. A closed-loop system according to claim 1, wherein the honing material comprises a photocatalytic slurry, and the advanced decontamination process comprises photocatalytic reaction between the photocatalytic slurry and contaminants in the contaminated fluid.

5. A closed-loop system according to claim 4, wherein the photocatalytic reaction is provided by a UV light source.

6. A closed-loop system according to claim 4, wherein the photocatalytic slurry comprises TiO₂.

7. A closed-loop system according to claim 1, further comprising a UV reactor providing a photolytic reaction sufficient to disinfect contaminants in the contaminated fluid.

8. A closed-loop system according to claim 1, wherein the advanced decontamination process comprises a hydrogen peroxide or ozone system.

9. A closed-loop system according to claim 1, wherein the contaminated fluid is contaminated drinking water or tertiary water for reuse.

10. A closed-loop system according to claim 1, further comprising a blowdown, the blowdown sufficient to eliminate suspended solids from the closed loop.

11. A closed-loop system according to claim 1, wherein the closed-loop system is a stand-alone unit with an inlet for receiving contaminated fluid and an outlet for releasing decontaminated fluid.

12. A closed-loop system according to claim 1, wherein the honing material scrubbing foulants from the filtration membrane provides a dynamic filter coating that results in an effectively smaller filtration pore size at the membrane than a membrane without honing material.

13. A closed-loop system according to claim 12, wherein a flow of contaminated fluid through the filtration membrane with the dynamic filter coating is 2000 gal/ft² per day with an effective filtration pore size at the membrane of about 12 nm.

14. A method of decontaminating a contaminated fluid within a closed-loop system, the method comprising:
passing the contaminated fluid through a filtration membrane;
providing a honing material in the contaminated fluid, the honing material sufficient to scrub foulants from the filtration membrane as the contaminated fluid is passing through the filtration membrane; and
performing an advanced decontamination process on the contaminated fluid sufficient to destroy, by oxidation and/or reduction, biological and organic contaminants from the contaminated fluid.

15. A method according to claim 14, wherein the filtration membrane is a cross-flow filtration membrane.

16. A method according to claim 15, wherein the cross-flow filtration membrane is comprised of ceramic.

17. A method according to claim 14, wherein the honing material comprises a photocatalytic slurry, and performing the advanced decontamination process comprises causing a photocatalytic reaction between the photocatalytic slurry and contaminants in the contaminated fluid.

18. A method according to claim 17, further comprising causing the photocatalytic reaction with a UV light source in the closed-loop.

19. A method according to claim 17, wherein the photocatalytic slurry comprises TiO₂.

20. A method according to claim 14, further comprising providing a photolytic reaction in the closed loop with a UV reactor sufficient to disinfect contaminants in the contaminated fluid.

21. A method according to claim 14, wherein performing the Advanced Oxidation Process comprises performing the advanced decontamination process with a hydrogen peroxide or ozone system.

22. A method according to claim 14, wherein the contaminated fluid is contaminated drinking water or tertiary water for reuse.

23. A method according to claim 14, further comprising blowing down suspended solids from the closed loop.

24. A method according to claim 14, wherein the recited steps are all performed in a stand-alone unit with an inlet for receiving contaminated fluid and an outlet for releasing decontaminated fluid.

25. A method according to claim 14, wherein the honing material scrubbing foulants from the filtration membrane further comprises providing a dynamic filter coating on the filter membrane that results in an effectively smaller filtration pore size at the membrane than a membrane without honing material.

26. A method according to claim 25, wherein providing a honing material further comprises flowing the contaminated fluid having the honing material through the filtration membrane with the dynamic filter coating is 2000 gal/ft² per day with an effective filtration pore size at the membrane of about 12 nm.

27. A closed-loop system for decontaminating a contaminated fluid, the system comprising:
a cross-flow filtration membrane;
a photocatalytic slurry in the contaminated fluid sufficient to scrub foulants from the filtration membrane as the contaminated fluid is filtered by the filtration membrane;
a UV light source providing a photolytic reaction sufficient to disinfect contaminants in the contaminated fluid; and
an advanced decontamination process comprising a photocatalytic reaction, caused by the UV light source, between the photocatalytic slurry and contaminants in the contaminated fluid sufficient to destroy, by oxidation and/or reduction, biological and organic contaminants from the contaminated fluid.

28. A closed-loop system according to claim 24, wherein the cross-flow filtration membrane is comprised of ceramic.

29. A closed-loop system according to claim 24, wherein the photocatalytic slurry comprises TiO₂.

30. A closed-loop system according to claim 24, wherein the contaminated fluid is contaminated drinking water or tertiary water for reuse.

31. A closed-loop system according to claim 24, further comprising a blowdown, the blowdown sufficient to eliminate suspended solids from the closed loop.

32. A closed-loop system according to claim 24, wherein the closed-loop system is a stand-alone unit with an inlet for receiving contaminated fluid and an outlet for releasing decontaminated fluid.

33. A closed-loop system according to claim 24, wherein the honing material scrubbing foulants from the filtration membrane provides a dynamic filter coating that results in an effectively smaller filtration pore size at the membrane than a membrane without honing material.

34. A closed-loop system according to claim 33, wherein a flow of contaminated fluid through the filtration membrane with the dynamic filter coating is 2000 gal/ft² per day with an effective filtration pore size at the membrane of about 12 nm.
